(19) United States
(12) Patent Application Publication
(10) Pub. No.: US 2010/0277575 A1
(43) Pub. Date: Nov. 4, 2010

(54) METHOD AND APPARATUS FOR PROVIDING A 3D IMAGE VIA A MEDIA DEVICE

(75) Inventors: George Ismael, Chatsworth, CA (US); Steve Heinold, Chatsworth, CA (US)

Correspondence Address: SALIWANCHIK LLOYD & SALIWANCHIK;A PROFESSIONAL ASSOCIATION, PO Box 142950, GAINESVILLE, FL, 32614, US

(73) Assignee: Tetracam, Inc., Chatsworth, CA (US)

(21) Appl. No.: 12/771,828

(22) Filed: Apr. 30, 2010

Related U.S. Application Data
(60) Provisional application No. 61/174,197, filed on Apr. 30, 2009.

(51) Int. Cl. H04N 13/04; G02B 27/22

(52) U.S. Cl. 348/53; 359/464; 348/E13.075

(57) ABSTRACT

Embodiments of the subject invention relate to a method and apparatus for providing a 3D image and/or 3D video. Specific embodiments can provide a 3D image and/or 3D video via a handheld media player. Examples of handheld media players via which embodiments can provide a 3D image and/or 3D video include, but are not limited to, an IPod®, a personal digital assistant (PDA), a cell phone, or an IPhone®. In accordance with specific embodiments of the invention, the problem of viewing three-Dimensional (3D) images on personal or handheld media devices is solved by the use of a compatible 3D viewer. Embodiments of the viewer, can provide a 3D experience to a user from images provided on the smaller viewscreen of a smaller, personal, or handheld media device. Specific embodiments described herein provide a 3D viewer that can present two stereoscopic images (i.e., 2-Dimensional (2D) images, having horizontal disparity) to a user's or viewer's eyes, such that each eye sees only one of the two stereoscopic images. By the process of stereopsis, the images are combined by the brain into a single 3D image giving the sensation, or perception, of depth and/or distance.

### CROSS-REFERENCE TO RELATED APPLICATION

The present application claims the benefit of U.S. Provisional Application Ser. No. 61/174,197, filed Apr. 30, 2009, which is hereby incorporated by reference herein in its entirety, including any figures, tables, or drawings.

### BACKGROUND OF INVENTION

Stereopsis is the process by which the visual perception of depth is obtained by viewing two slightly different projections of an image. Stereoscopic systems provide the sensation of a three-dimensional (3D) image by presenting a first 2-Dimensional image to the right eye of the viewer and a second, slightly different 2-Dimensional image to the left eye of the viewer. The first and second images can be taken from two points of view that are approximately the spacing between the viewer's right and left eyes. The viewer's visual perception then perceives the horizontal disparity between the first image presented to the right eye and the second image presented to the left eye as a 3D image. To achieve the full 3D effect, specialized stereoscopic eyeglasses that can control delivery of the images to each eye must typically be worn. Thus, the isolated images observed by each eye are able to “trick” the brain, which perceives the dual images as a single image with 3D qualities.

The use of stereoscopic imagery has evolved to the production of 3D movies and/or videos for theatrical release and mass viewing audiences. As 3D technology improves and the popularity of movies made in such fashion increases, it has become more cost effective to produce and distribute them. However, there are a limited number of theaters both in the U.S. and abroad that are capable of showing 3D movies. Unfortunately, the cost of upgrading theaters to 3D quality screens and equipment has not yet become as cost effective as making the movies themselves.

Concurrent with the rise in 3D popularity is the increased prevalence of personal media devices capable of displaying high quality images for personal on-demand viewing. There are currently available 3D capable home television and video gaming platforms that are gaining popularity. However, the technology has not translated to smaller personal media devices. The small screen size of such devices coupled with the necessity of eyewear to experience the 3D effects has limited the experience to large theater screens or home audiences.

A continual concern with the rise in digital media use is the preservation of copyright protections and security associated therewith. The internet connectivity of most devices and the increased popularity and convenience of providing digital media through the internet has only increased those concerns. To reduce the incidences of piracy, various types of security features can be introduced into the media itself or into the equipment on which it is utilized. Each method has its own advantages and disadvantages.

Introducing security features into the digital media can ensure that each use is proper and legal. However, each digital media manufacturer can use different security techniques. This, in turn, necessitates that the equipment used therewith be configured to account for or eliminate the variety of security features used for each digital media manufacturer. This can require extensive and often costly coordination between the digital media and the equipment manufacturers. Introduction of security features into equipment often limits the equipment to use with only specific digital media or digital media manufacturers. Usually more generalized security measures are utilized to accommodate more equipment manufacturers.

Configuring equipment or devices to have built-in security features can ensure that only authorized digital media is utilized. The equipment itself is able to compensate for any security features used by the digital media manufacturer. This can allow digital media manufacturers to utilize more sophisticated security measures. But, the selection of digital media available for use on the device is often limited to that of digital media that utilizes only those specifically designed security measures.

Given the limitations that currently exist for the continued growth of 3D media, there is a need for other types of media, whether personal, handheld devices, or larger standing devices to have the capability of displaying 3D media. To accomplish this, there is a further need for 3D eyewear that can take advantage of smaller screen sizes, that is easy and convenient to use, and that can provide, perhaps even enhance, the 3D experience. It is advantageous for the presentation of 3D media to personal, handheld, standing, or other types of media devices to be secure, deliverable via the internet, and allow for a variety of devices to utilize the media.

### BRIEF SUMMARY

Embodiments of the subject invention relate to a method and apparatus for providing a 3D image and/or 3D video. Specific embodiments can provide a 3D image and/or 3D video via a handheld media player. Examples of handheld media players via which embodiments can provide a 3D image and/or 3D video include, but are not limited to, an IPod®, a personal digital assistant (PDA), a cell phone, or an IPhone®.

In accordance with specific embodiments of the invention, the problem of viewing three-Dimensional (3D) images on personal or handheld media devices is solved by the use of a compatible 3D viewer. Embodiments of the viewer, can provide a 3D experience to a user from images provided on the smaller viewscreen of a smaller, personal, or handheld media device. Specific embodiments described herein provide a 3D viewer that can present two stereoscopic images (i.e., 2-Dimensional (2D) images, having horizontal disparity) to a user's or viewer's eyes, such that each eye sees only one of the two stereoscopic images. By the process of stereopsis, the images are combined by the brain into a single 3D image giving the sensation, or perception, of depth and/or distance.

Embodiments of the subject invention provide a viewer that can be conveniently coupled to the viewing screen of a personal media device. Embodiments of the viewer can be easily coupled and uncoupled to the viewer for hands-free viewing while other embodiments can allow the user to hold the viewer and/or the personal media device in place. Certain embodiments herein describe a viewer intended for reuse. Other embodiments describe a viewer that can be assembled from inexpensive materials for disposable use.

Various optics within the viewer can compensate for the various types of personal media devices that can be used. For example, certain optics can enlarge the images from the media device to present a larger viewing image. Certain other viewer optics can also adjust for the horizontal displacement of the dual stereoscopic images, so that they are aligned with each respective eye. To maximize the viewing area available for each image on a particular view screen, it can be more advantageous to present the images vertically rather than horizontally, meaning the horizontal axes of the two images are parallel and offset in a direction perpendicular to the horizontal axes rather than parallel and collinear, and that the images are rotated plus or minus 90° with respect to the user's eyes on the personal media device and are rotated as needed, for example minus or plus 90°, respectively, before being provided to the user's eyes. Thus, other optical embodiments are able to compensate for a vertical presentation, so that the eyes still perceive them as horizontal, for example by rotating the images plus or minus 90°, where rotating the image minus 90° is the same as rotating the image 270°.

Embodiments are also presented that describe the presentation of the 3D media utilizing software that incorporates one or more security features into the 3D media. In one embodiment, anamorphic distortions are introduced into the 3D media. Examples of anamorphic distortions that can be introduced, include, but are not limited to, stretching the images along the vertical axis, along the horizontal axis, or both; compressing the images along the vertical axis, along the horizontal axis, or both; and/or a combination thereof. Optics within the viewer are able to compensate for the distortions so that the media and the associated 3D effects can be seen without distortion.

FIG. 3 shows an exploded view of an optical system for providing a 3D image, a series of 3D images, and/or a 3D video to a viewer via a handheld media player. Two images, or image frames, are presented, or painted, from top to bottom on the small media player. A system of prisms and lenses is used to separate the two images for the left and right eye of the viewer. The still or moving images are generated with spatial offsets for the left and right eye to provide 3D viewing. The handheld media player can receive the right and left image in landscape or portrait orientations on the media player, with the images stacked either vertically or side by side. In a specific embodiment one or more of the right and left images can be squashed or stretched along one or both axes to optimize the use of the pixels on the display. The aspect ratio can then be restored for the viewer by, for example, corrective optics.

In a specific embodiment, a pair of close up glasses can be used for viewing the media player and an optional holder can be provided to hold the media player with respect to the glasses at, for example, a fixed distance from the glasses. Preferably, the media player is held at a distance that is approximately the focal length of the close focus viewing glasses, or lenses. FIG. 4 shows a specific embodiment that utilizes close focus viewing glasses and a stiff frame to hold the glasses and the media player a certain distance apart. The stiff frame is shown in skeletal forms, but can have a variety of shapes and/or designs that allow the media player to be held a certain distance from the glasses. FIG. 4 shows an optional barrier that can block the viewer's eyes from the image intended for the other eye. The blocking of the images to the other eye, by the optional barrier, can be complete or partial blocking, as partial blocking can be sufficient in certain circumstances. Referring to FIG. 4, two images are presented side by side on the media player. The aspect ratio and placement of the image frames is correct for viewing in the displayed files via a set of close viewing lenses. The set of close viewing lenses is held at a fixed distance from the display by a stiff frame, box, or other appropriate structure. Preferably, the set of close viewing lenses are held at a distance from the display device that is approximately the focal length of the close viewing lenses. In a further preferred embodiment, the distance between the set of close viewing lenses and the display device can be adjusted such that each user can adjust such separation distance to best match the user's preferences.

FIG. 5 shows an embodiment of an optical system that can be used to provide a 3D image to a user. Two frames, or images, are presented side by side on the small media player. A system of prisms and lenses is used to spread the two frames apart for comfortable viewing. To make use of all the pixels in the display, the images are compressed horizontally in the original media, then corrected to a normal aspect ratio by, for example, cylindrical lenses. The still or moving images on the display are generated with spatial offsets for the left and right eye to provide 3D viewing.

FIG. 6 shows an embodiment of an optical system that can be used to provide a 3D image to a user. Two frames are presented vertically on the media player in a wide aspect ratio. Prisms are used to adjust the apparent positions of the images for left and right viewing. The right and left images are brought to a common horizontal axis and separated to be at a distance that is closer to the spacing between a user's right and left eyes.

FIG. 7 shows a viewing enclosure that can hold a media player that is used to display an image for a viewer's, or user's, right eye and an image for a user's left eye that can be viewed by a user to provide the user a 3D image. Also shown in FIG. 7 is an optional set of ear plugs that can be used to provide audio to the user. Other apparatus can be used to provide audio to the user, including, but not limited to, headphones and speakers. In a specific embodiment, the ear plugs, or other audio apparatus can provide dimensional effects, including one or more of the following: locating sounds up and down, locating sounds right to left, and locating sounds in front of and behind the user, and locating sounds in 3D for the user. The viewing system can be enclosed to eliminate distractions and provide better apparent brightness and clarity to the 3D images. The enclosure may be designed to mount the unit vertically (portrait) horizontally (landscape) or both.

FIG. 8 shows an optical system using one or more mirrors to guide the right and left images to the correct eyes of the user. Two images are presented side by side on the small media player. A system of mirrors and lenses is used to spread the two frames apart for comfortable viewing. To make use of all the pixels in the display, the images can be compressed horizontally in the original media, then corrected to a normal aspect ratio by, for example, cylindrical lenses. The still or moving frames on the display are generated with spatial offsets for the left and right eye to provide 3D viewing.

FIG. 9 shows and optical system similar to the system of FIG. 5, where the horizontal displacement prism system aligns the images with the viewer's eyes and rotates the images 90 degrees.

FIG. 10 shows an optical system similar to the system of FIG. 3, where the aspect ratio of the images is adjusted using anamorphic prism shapes.

The embodiments shown in FIGS. 1-8 can be used in conjunction with a system for delivering 3D images and/or 3D videos to a viewer via a handheld media player. The delivery system can utilize the interne or other communication system to deliver the 3D image or 3D video data to the handheld media player. The system can incorporate security features to restrict the handheld media player to only play media files having the proper security information. In a specific embodiment, distortions such as anamorphic distortions can be introduced in the media files that are difficult to eliminate without use of the appropriate viewing system. In a further specific embodiment, the distortion can maximize the number of pixels available for each frame.

### BRIEF DESCRIPTION OF DRAWINGS

In order that a more precise understanding of the above recited invention can be obtained, a more particular description of the invention briefly described above will be rendered by reference to specific embodiments thereof that are illustrated in the appended drawings. It should also be understood that the drawings presented herein may not be drawn to scale and that any reference to or implication of dimensions in the drawings or the following description are specific to the embodiments disclosed. Any variations of these dimensions that will allow the subject invention to function for its intended purpose are considered to be within the scope of the subject invention. Thus, understanding that these drawings depict only typical embodiments of the invention and are not therefore to be considered as limiting in scope, the invention will be described and explained with additional specificity and detail through the use of the accompanying drawings in which:

FIG. 1A-1C illustrate an embodiment of a viewer housing design that incorporates dual eye windows and one or more slots at the distal end that permit a personal media device to be fitted and held in place over the image window.

FIG. 1D illustrates one embodiment of optical components that can be utilized in the viewer of FIGS. 1A-1C.

FIGS. 2A-2D illustrate an embodiment of a foldable viewer that can be constructed by manipulating various panels and fitting optical components thereto.

FIG. 3 shows an exploded view of an optical system for viewing D media on a viewer via a personal media player, in accordance with an embodiment of the subject invention.

FIG. 4 shows a specific embodiment that utilizes close focus viewing glasses and a stiff frame to hold the glasses and the media player a certain distance apart.

FIG. 5 shows an embodiment of an optical system that can be used to provide 3D media to a user, where two frames are presented side by side on the media player and a system of prisms and lenses is used to spread the two frames apart for comfortable viewing.

FIG. 6 shows an embodiment of an optical system that can be used to provide 3D media to a user, where two frames are presented vertically on the media player in a wide aspect ratio and prisms are used to adjust the apparent positions of the images for left and right viewing.

FIGS. 7A, 7B, and 7C show viewing enclosures that can hold a media player that is used to display a 2D image for a viewer's right eye and a 2D image for a viewer's left eye that can be viewed by a viewer to provide the viewer a 3D image. FIGS. 7A and 7B illustrate a housing that can hold a media device in a vertical (portrait) orientation. FIG. 7C illustrates a housing that can hold a media device in a horizontal (landscape) orientation.

FIG. 8 shows an optical system using one or more mirrors to guide the right and left images to the correct eyes of the viewer, where two images are presented side by side on the small media player and a system of mirrors and lenses is used to spread the two frames apart for comfortable viewing.

FIG. 9 shows and optical system similar to the system of FIG. 5, where the horizontal displacement prism system aligns the 2D images with the viewer's eyes and rotates the images 90 degrees.

FIG. 10 shows an optical system similar to the system of FIG. 3, where the aspect ratio of the images is adjusted using anamorphic prism shapes.

FIGS. 11A and 11B show a specific embodiment of a separate attachable optics panel 80 that can be used with various embodiments of the invention, where dimensions are shown in inches.

FIG. 12 shows another embodiment of a molded separate attachable optics panel 80 that utilizes rectangular lenses.

### DETAILED DISCLOSURE

Embodiments of the subject invention relate to a method and apparatus for providing a 3D image. Specific embodiments can provide a 3D image via a handheld or personal media player. Examples of media players that can be utilized with embodiments of the subject invention include, but are not limited to, an IPod Phone, IPod Touch, a personal digital assistant (PDA), Blackberry®, cellular phone, IPad, or other portable devices capable of displaying images.

The following detailed description will disclose that the subject invention is particularly useful in the field of 3D media, in particular devices used for viewing multiple sequential 3D images, e.g., movie or film productions. Specific embodiments are directed to the field of digital images and digital 3D images. However, a person with skill in the art will be able to recognize numerous other uses that would be applicable to the devices and methods of the subject invention. While the subject application describes a use particular to handheld media devices, modifications for use with other types of devices, e.g., non-portable devices, apparent to a person with skill in the art and having benefit of the subject disclosure are contemplated to be within the scope of the present invention.

In the description that follows, a number of terms related to optics and optical engineering are utilized. In order to provide a clear and consistent understanding of the specification and claims, including the scope to be given such terms, the following definitions are provided.

The terms “user”, or “viewer” refer to any person utilizing a personal media device to view images.

The terms “image”, “frame” or “image frame” are used throughout the subject application. It should be understood that the term encompasses any image, presented singularly or in progressive or sequential frames, e.g., movie or film, digital, analog, or other, that can be viewed on any media device.

The term “media device” or “media player” as used herein refers to any device capable of displaying an image, frame, or image frame. This can include portable devices, such handheld devices, or personal media devices, and non-portable devices, such as standing or mounted devices or any other image displaying device that can be viewed by one or more authorized persons. Such devices can include, but are not limited to, cell phones, computers, televisions, portable internet access devices, digital video display (DVD) devices, computer disk (CD) devices, video display devices, and/or any other device capable of displaying an image, frame or image frame and being utilized with the embodiments of the subject invention.

The terms “normalized image” or “normalized orientation” as used herein refers to an image presented in a standard perspective, wherein the horizon is seen as horizontal. Thus, a “non-normalized image” or “non-normalized orientation” would refer to an image wherein the horizon is not seen as horizontal.

Also, as used herein, and unless otherwise specifically stated, the terms “operable communication” and “operably connected” mean that the particular elements are connected in such a way that they cooperate to achieve their intended function or functions. The “connection” may be direct, or indirect, physical or remote.

In addition, references to “first”, “second”, and the like (e.g., first and second eye piece), as used herein, and unless otherwise specifically stated, are intended to identify a particular feature of which there can be at least two. However, these references are not intended to confer any order in time, structural orientation, or sidedness (e.g., left or right) with respect to a particular feature. Further, references to “first” do not necessarily imply that there is at least two.

Finally, reference is made throughout the application to the “proximal end” and “distal end.” As used herein, the proximal end is that end placed nearest the user eye(s). Conversely, the distal end of the device is that end in contact with or closest to the handheld media device.

As used in the specification and in the claims, the singular for “a,” “an” and “the” include plural referents unless the context clearly dictates otherwise.

With reference to the attached figures, which show certain embodiments of the subject invention, it can be seen that specific embodiments of the viewer 10 can incorporate several components, including a housing 50 having at least one eye window 54 and at least one image window 56. Various optical components can be positioned within a region, or chamber, 58 to guide and/or modify the image of the at least one image window as the image travels to the at least one eye window. The optical components utilized can vary depending upon the desired image effect, and, in general, the optical components can include one or more of the following: lenses, prisms, mirrors, filters, and/or other optical components. The optical components can receive one or more images from a handheld media device 20 and alter, guide, redirect, and/or manipulate those images.

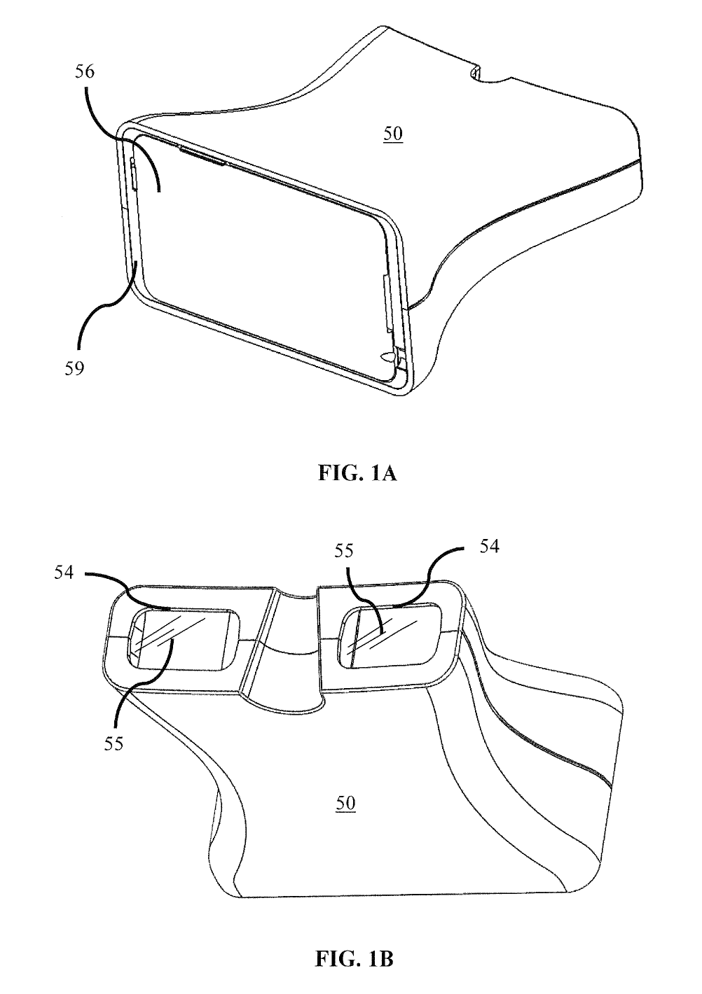

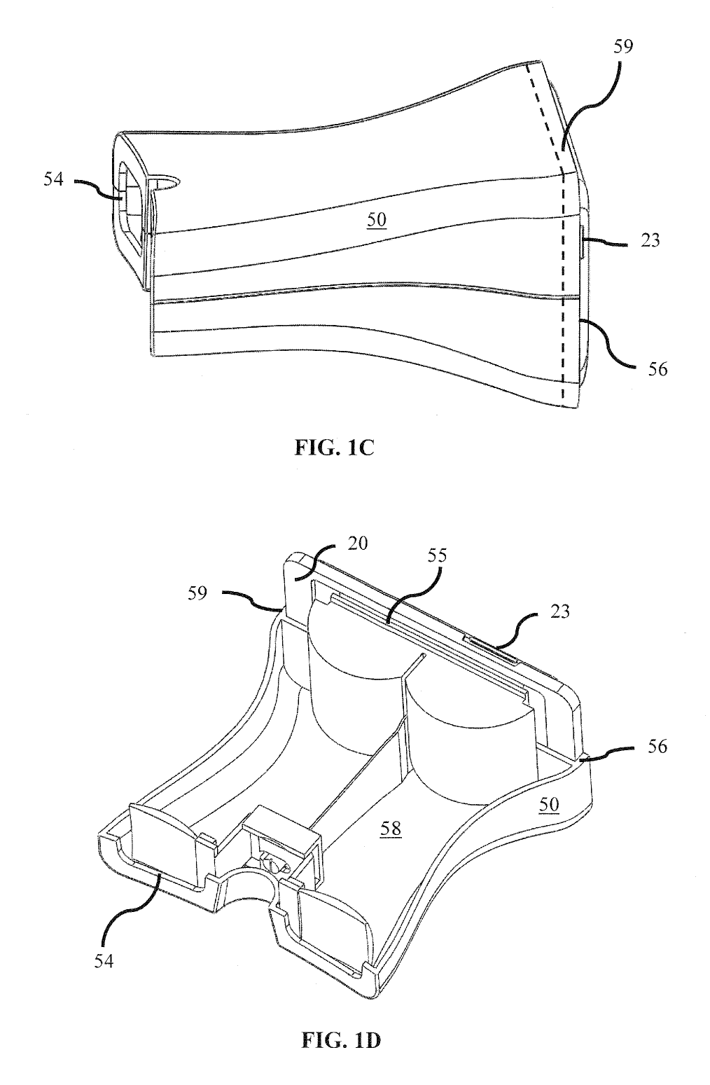

With regard to the housing 50, it can be seen, for example, in FIGS. 1A-D, that there can be at least one eye window 54 located at the proximal end. An eye window can be, in general, an opening within the housing through which a user can see an image. In particular, the user can see through an eye window an image that has been corrected, enhanced, altered, or otherwise manipulated by the optics. One or more lenses, such as a close focus viewing lens, can be located at the eye window and in specific embodiments, the lens can be integral with the housing, such as the embodiment shown in FIG. 12. In specific embodiments, the optical components can reside within the chamber 58. In one embodiment, the eye window has a cover 55 that is sufficiently transparent to permit viewing of an image therethrough. The cover can be clear or any of one or more various colors. The materials employed for the cover can be any of a variety of materials, including, but not limited to, glass, plastic, ceramic, polycarbonate, metal, crystal, liquid, or combinations thereof. In one embodiment, the cover does not have optical qualities, that is, it does not manipulate an image prior to presentation to the user. In an alternative embodiment, the lens does have optical qualities, such that it does operate to manipulate an image prior to presentation to the user. In further specific embodiments, the user can view the images without viewing through an eye window, such as when the housing is more open or only provides structure on one, two, or three sides, or other portions, of one or more eye lenses, or the user places the user's eyes at a focal point at the images to be viewed with or without one or more eye lenses.

In one embodiment, the housing is configured with two separate eye windows, one for each eye of the user. An example of this embodiment is shown in FIGS. 1A-D. As will be discussed below, the optical components or other structures, for example, within the chamber 58, are capable of presenting a separate image to each eye, to facilitate 3D imagery. With this embodiment, the user can align their left and right eye with left and right eye windows, respectively.

In an alternative embodiment, the eye window is a single opening through which a user can view an image with both eyes simultaneously. In a further embodiment, the eye window can be a single elongated opening through which a user can view images with both eyes simultaneously. With this embodiment, optical components and/or structures within the viewer 10 are capable of presenting separate images to each of the user's eyes, to facilitate 3D imagery.

The image presented to the user can be obtained from any of a variety of media devices 20. In one embodiment, the image displayed by a media device 20 can be observed by aligning the screen 22 of the media device with an image window 56 on the distal end of the housing 50. As described above for the eye window 54, the image window 56 can be, in general, one or more openings within the distal end of housing through which one or more images displayed on the handheld media device 20 can be seen simultaneously by a user. In particular, when a media device displaying an image is aligned with the image window 56, the user can observe through an eye window 54 that image after it has been corrected, enhanced, altered, or otherwise manipulated by the optics components, for example within the chamber 58. In one embodiment, the image window is has a cover 55 that is sufficiently transparent to permit transmission of an image therethrough. The cover can be clear or any of one or more various colors. The materials employed for the cover can be any of a variety of materials, including, but not limited to, glass, plastic, ceramic, polycarbonate, metal, crystal, liquid, or combinations thereof. In one embodiment, the cover does not have optical qualities, that is, it does not manipulate an image prior to presentation to the user. In an alternative embodiment, the cover does have optical qualities, such that it does operate to manipulate an image prior to presentation to the user.

In one embodiment, the housing 50 is configured with a single image window 56. In an embodiment, the dimensions of the image window are such that the separate images displayed by the media device 20 are visible through the window simultaneously. An example of this embodiment is shown in FIGS. 1A-D. As will be discussed below, optical components or other structures within the chamber 58 are capable of presenting the images separately, such that a single image can be presented to each eye, to facilitate 3D imagery.

In an alternative embodiment, the housing is configured with two image windows through which a user can view an image with both eyes simultaneously. In a further embodiment, the eye window can be a single elongated opening through which a user can view images with both eyes simultaneously. With this embodiment, optical components and/or structures within the viewer 10 are capable of presenting separate images to each of the user's eyes, to facilitate 3D imagery.

In an alternative embodiment, the housing is configured with two separate image windows, one for each image displayed by the media device. As will be discussed below, the optical components or other structures are capable of manipulating and presenting a separate image to each eye of the user, to facilitate 3D imagery.

The housing itself can be configured as a reusable device intended for multiple use. The design of the housing can also include various ergonomic features as consideration for the comfort of the user. Media devices 20 often include ports 23 that can be utilized to operably attach various accessories 24, such as, for example, audio devices (e.g., headphones, earbuds, speakers, etc.), power cords, interne access lines, etc. To accommodate the attachment of accessories 24, the housing can include one or more openings or otherwise provide access to the one or more ports 23. In one embodiment, the housing is a hard or semi-hard case that defines the chamber 58 therein, wherein the optical components are arranged. In a further embodiment, the housing is sealed or cannot be opened to permit access to the optical components. FIGS. 1A-D illustrate an example of a housing that is not designed to be opened. In an alternative embodiment, the housing, or some portion thereof, can be opened to permit access to the optical components therein.

As discussed above, the image or images utilized for providing the 3D experience are obtained from a media device 20 that can be aligned with the image window 56 of the viewer 10. Proper alignment of the image with the image window can ensure that it is also aligned with the optical system 100. However, it can be impractical or uncomfortable for a user to manually align and hold the media device in place, especially for extended periods. Embodiments of the subject invention include a housing having one or more attachments, features, apparatuses or other means that permit proper alignment of a media device with a viewer. In further embodiment, the attachments, features, apparatuses or other means on the housing can maintain the alignment of the media device for an extended period. This provides the advantage of allowing a user to watch a 3D image presentation (e.g., movie, slide show, etc.) without having to align and hold the media device for an extended period of time.

Further specific embodiments allow a user to change the distance between the close focus viewing lenses, such as shown in FIG. 1D, and the media display device, such that a user can optimize the 3D image as desired. In yet a further embodiment, the horizontal separation of the close focus viewing lenses can be adjusted to fit with different users' eye separations. Such adjustments can be facilitated by simple mechanical actions such as sliding the structure holding the lenses with respect to the structure holding the media display device or other more complicated mechanisms such as a thumb screw or other mechanisms known in the art.

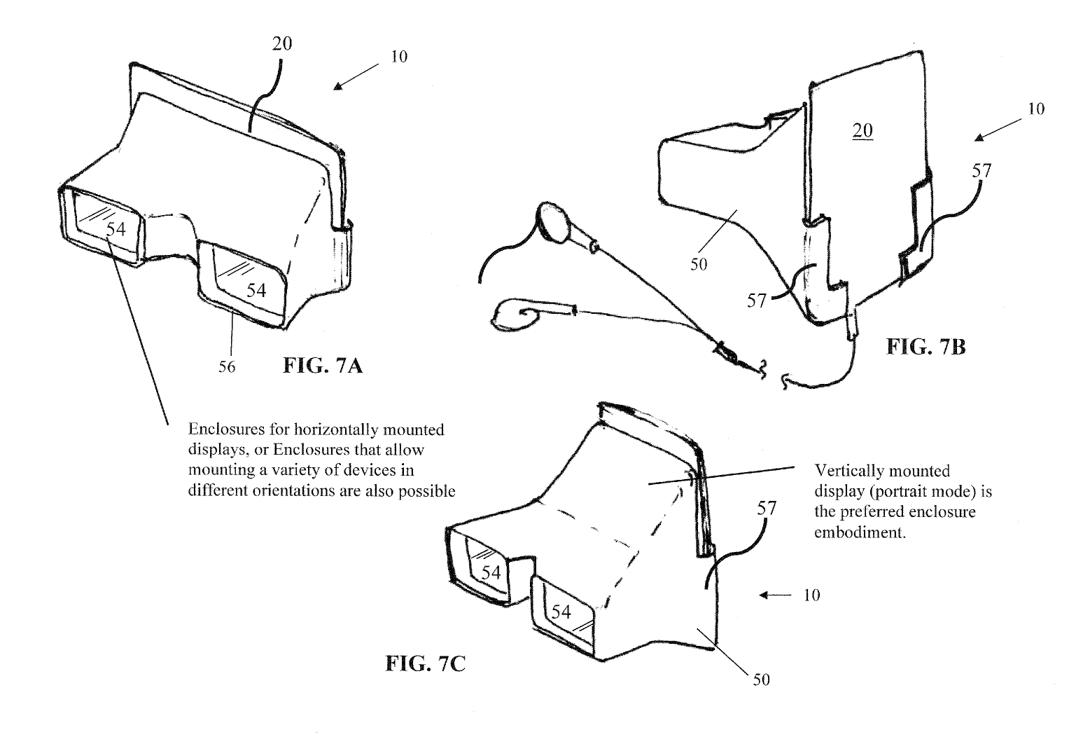

In one embodiment, the housing includes a frame overlap 59, an example of which is shown in FIGS. 1A and 1C. The frame overlap has dimensions which allow the media device (e.g., I-Touch® or BlackBerry®) to be properly aligned with the image window. In one embodiment, the media device can be aligned in a portrait orientation, such as shown for example in FIGS. 7A and 7B. In an alternative embodiment, the media device can be aligned in a landscape orientation, as shown, for example, in FIG. 7C. In one embodiment, the frame overlap is continuous around the image window, which can reduce or eliminate extraneous light from entering around the edges of the media device and image window. An example of this is shown in FIGS. 1A and 1C. In an alternative embodiment, the frame overlap 59 can be a series of discontinuous tabs or projections around the image window. To maintain the media device within the frame, any of a variety of techniques or devices can be utilized. A person with skill in the art and benefit of the subject disclosure would be able to devise any of a variety of techniques and devices for maintaining a media device within a frame overlap. Any and all such variations are considered to be within the scope of the embodiments of the subject invention.

In an alternative embodiment, the housing includes one or more support flanges 57 located around the periphery of the image window 56. In one embodiment, a media device can be inserted between the support flanges and the image window. The support flanges 57 facilitate proper alignment of the media device and hold the media in place against or near the image window. Support flanges can be used to hold a media device in a landscape or portrait position. Support flanges can also be adjustable to accommodate different media devices. In a further embodiment, the location of the support flanges allows access to one or more ports 23 available on the media device for attachment of accessories 24. FIG. 7 illustrates examples of support flanges 57 utilized in accordance with embodiments of the invention.

The portability of media devices can make them easy to use in a multitude of locations. However, it may not be convenient to carry a viewer 10 as well as the media device in all situations or locales. It can be beneficial if viewers 10 could be obtained for temporary use and, further, if the viewers can be suitable priced to warrant disposal or recycling after such temporary use.

FIG. 1D shows the use of positive meniscus lenses as the close focus viewing lenses. A variety of magnifying lenses can be used as the close focus viewing lenses in accordance with various embodiments of the invention, depending on the circumstances. The positive meniscus lenses shown in FIG. 1D can be 30 mm wide by 22 mm tall in an embodiment. The media display can produce images that are 30 mm by 30 mm or 30 mm by 25 mm, side by side. Examples of other lenses that can be used as a close focus viewing lens in accordance with embodiments of the invention include, but are not limited to, single lenses such as planar convex lenses, which have a planar side and a convex side; positive meniscus lenses, which have a concave side and a convex side; double convex lenses, which have a first convex side and a second convex side; and lens systems with two or more lenses that allow a user to focus on the input image from the media display device such as achromatic lens systems, which have at least two elements so as to correct for the different focal lengths of different colors. FIG. 6 shows an example of an achromatic lens system.

FIG. 1D shows anamorphic correction lenses positioned near the media display device to correct for horizontal compression of the images on the media display device. Other anamorphic correction lenses can be used to correct horizontal stretching of the image on the display device and/or vertical stretching or compression of the media display device, which can also be useful when transitioning from a first aspect ratio to a second aspect ratio.

In an alternative embodiment, the housing is configured as a single use, limited use and/or disposable device. In a particular embodiment, the housing is pre-constructed from inexpensive and/or biodegradable materials that can be disposed of or recycled after a single use or a few uses. In a specific embodiment, the housing 50 is manufactured of a paper product, such as, for example, cardboard, pasteboard, or press board, which can have a stiff or semi-stiff construction. This can allow the viewer to be used at least once, or possibly several times, before the integrity of the viewer and/or optics therein is compromised. Any of a multitude of other materials could also be utilized to manufacture a disposable or recyclable viewer, including, but not limited to, plastics, metals, woods, ceramics, or any other material known to those with skill in the art. It is contemplated that any and all such variations are within the scope of the embodiments of the subject invention.

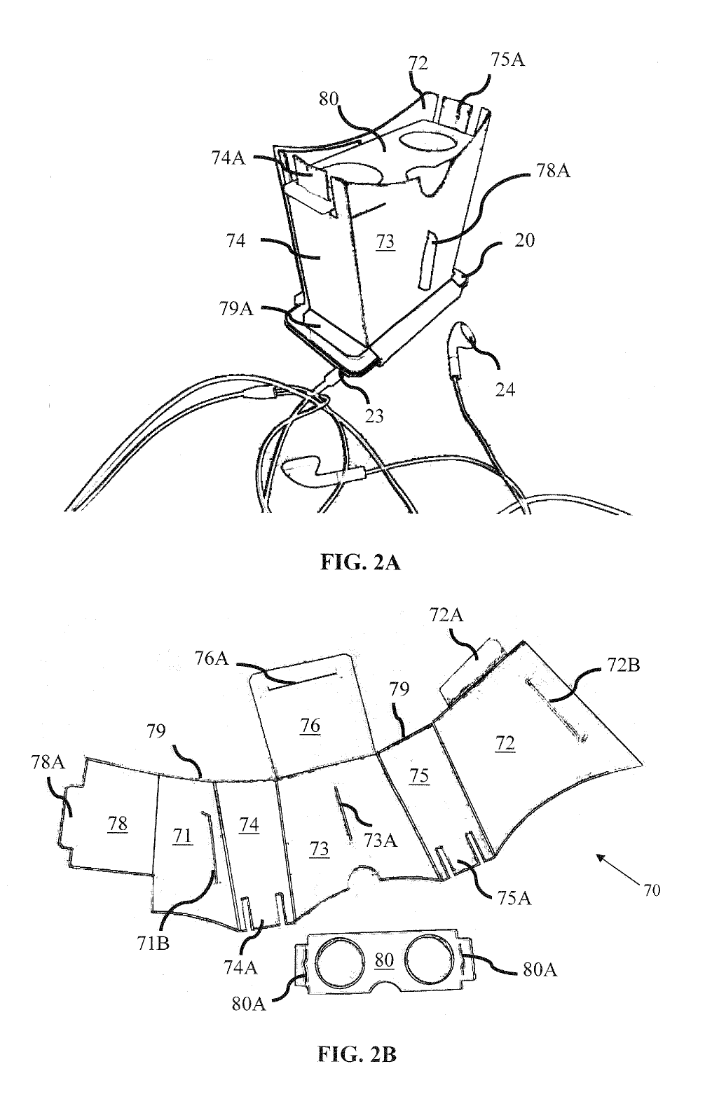

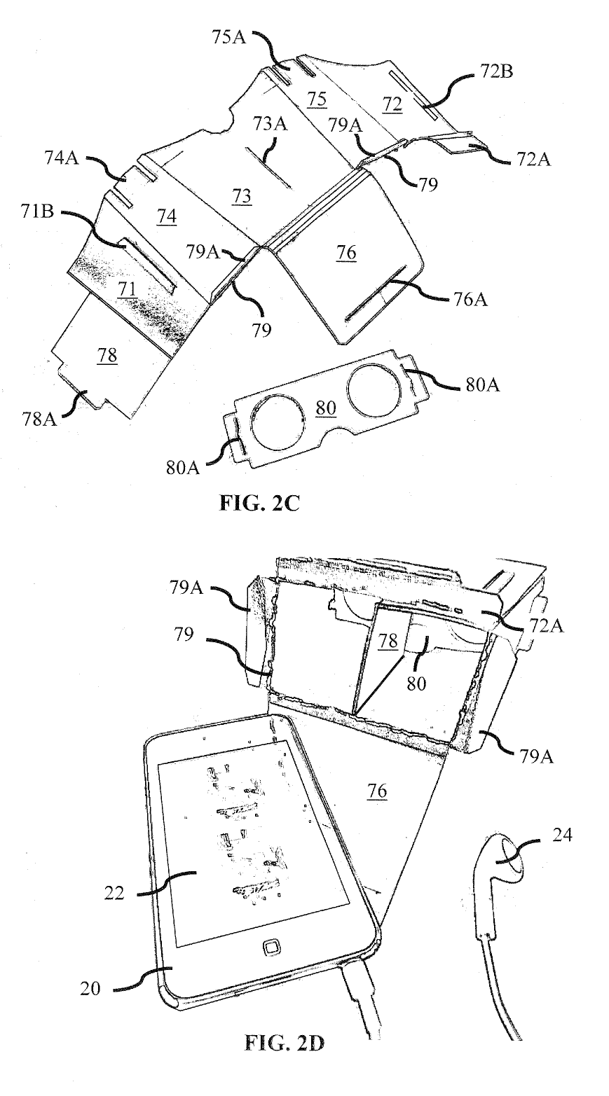

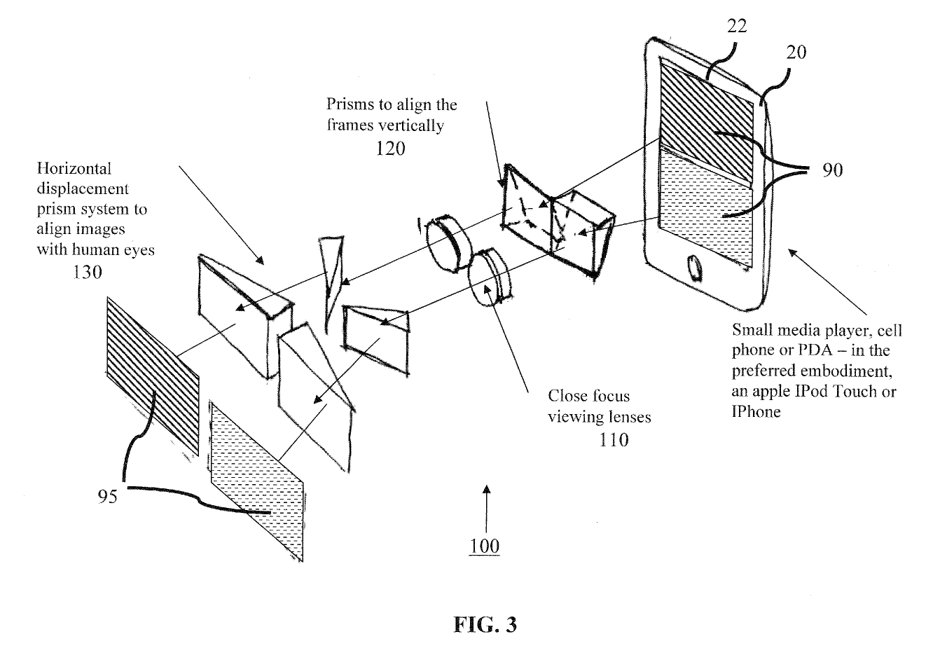

In a further embodiment, the housing 50 is configured as a collapsible device of one or more components that can be assembled into a viewer according to the embodiments of the subject invention. This can make manufacturing, packaging and transporting more cost effective, thus making a disposable viewer more efficacious. In one embodiment, the viewer housing 50 is configured as one or more flat sheets of foldably connected panels. In a more particular embodiment, the viewer housing is configured as a single flat sheet 70 with foldable panels and a separate attachable optics panel 80. FIGS. 2A-2D illustrate an example of this embodiment.

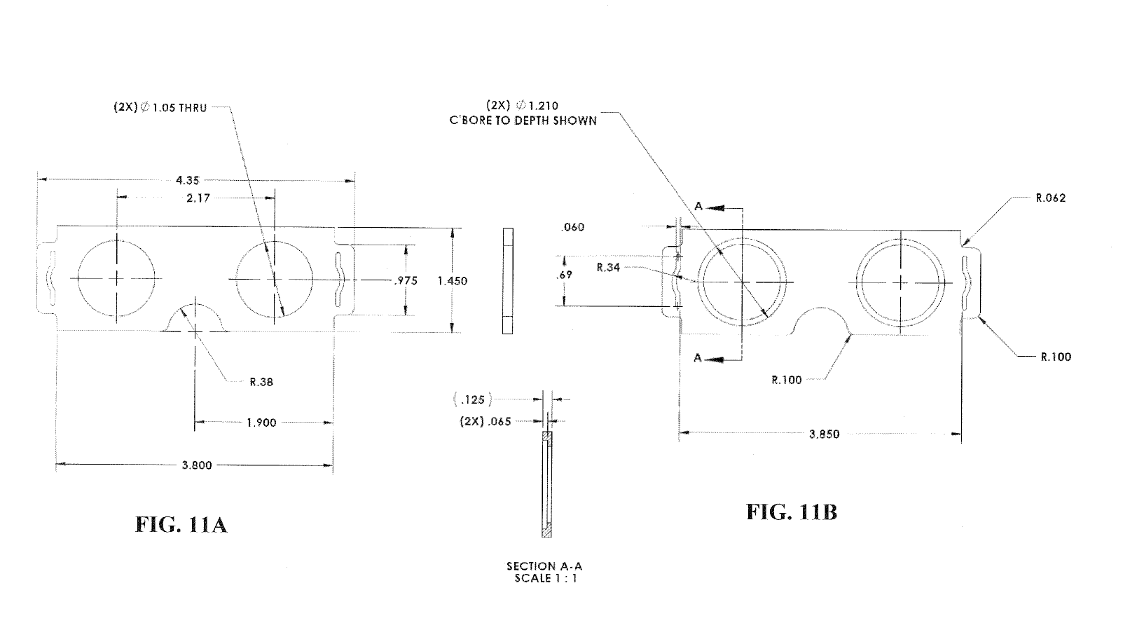

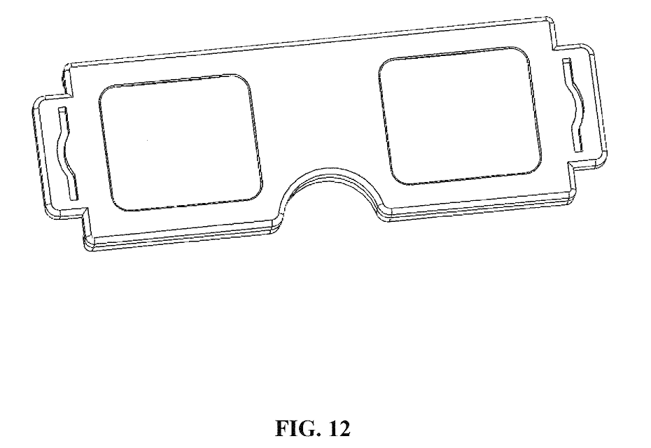

FIGS. 11A and 11B show a specific embodiment of a separate attachable optics panel 80 that can be used with, for example, the embodiment shown in FIGS. 2A-2D, where the dimensions are shown in inches. The optics panel can be made of cast acrylic sheet that is 0.125 inches thick and water clear with no finish, in a specific embodiment. The embodiment shown in FIGS. 11A and 11B utilizes circular lenses. FIG. 12 shows another embodiment of a separate optics panel 80 incorporating rectangular lenses, which has similar dimensions as shown in FIGS. 11A and 11B.

It can be seen in FIG. 2B that an embodiment of the invention arranged as a single flat sheet 70 having foldable panels can include a top panel 71, a closing panel 72, a bottom panel 73, a left side panel 74, a right side panel 75, an image window support panel 76, an image separator panel 78. By manipulating the individual panels along pre-configured fold lines a housing 50 having an interior chamber 58 can be constructed. To maintain the position of the panels once in place, various tabs and slots that can be cooperatively engaged can be provided at pre-determined locations. Further addition of an optics panel 80 can provide a viewer in accordance with the embodiments of the subject invention.

Referring to FIGS. 2B and 2C, construction of the housing can proceed by folding the panels along their respective fold lines as follows:

1. left side panel 74 and right side panel 75 can be folded upwards so as to be generally perpendicular to the bottom panel 73;
2. top panel 71 can be folded towards the right side panel, no as to be generally parallel with the bottom panel 73;
3. image separator panel 78 can be folded towards the bottom panel, so as to be generally perpendicular with the bottom panel, which will allow tab 78A on the image separator panel to be inserted into slot 73A located in the bottom panel;
4. closing panel 72 can be folded towards the left side panel until it is parallel with the top panel, which can allow tab 72B on the closing panel to be inserted into slot 71B in the top panel;
5. image support panel 76 can be folded towards the closing panel, which will allow tab 72A on the closing panel to be inserted into slot 76A in the image support panel;
6. Optics panel 80 can be attached to the left side panel 74 and the right side panel 75 by inserting tabs 74A and 75A, respectively into slots 80A on the optics panel.

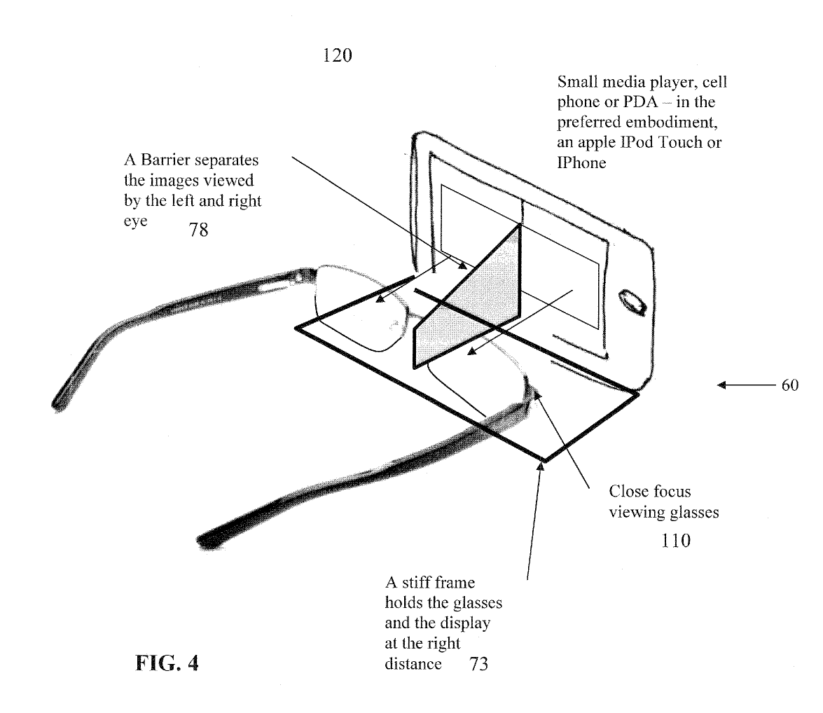

The image separator panel 78 is shown in FIGS. 2B and 2D. Additional types of image separators can be used, such as shown in FIG. 1D and FIG. 4. Various embodiments of a viewer in accordance with the invention can, optionally, incorporate various image separators, or barriers. A partial barrier can be used, such as a striated barrier, a grid barrier, or barriers with other structures that substantially prevent the user's eyes from viewing the image for the opposite eye (opposite image) or disturbs the recognition of the opposite image by the user's brain by defocusing or otherwise altering the opposite image. Accordingly, a translucent barrier can serve this function, as well as non-translucent barriers.

Once the housing 50 of the viewer 10 of this embodiment has been constructed, a media device 20 can be inserted between the image window support panel 76 and edge 79, which forms the image window 56, as shown, for example in FIG. 2A. In a further embodiment, one or more media device supports 79A can be foldably connected to the left and right side panels, such as shown, for example, in FIGS. 2A and 2C. Advantageously, access to one or more ports can be provided by this embodiment, even after the media device has been aligned with the image window, an example of which is shown in FIGS. 2A and 2D.

Slots 80A, shown in FIG. 2B, can allow the user to adjust the distance between the close viewing lenses attached to optics panel 80 and the image displayed on the media display device, by sliding slots 80A up and down inserting tabs 74A and 75B. Slots 80A can incorporate FIGS. 2A-2D can have portions of panels 73, 72, 74, and 75 that extend out so as to block out light, and can have an optional notch for the user's nose, when the user's eyes are about 20-35 mm from the lenses in panel 80. The spacing of the lenses in panel 80 can be in the range 60-65 mm, which can be greater than the spacing of the image on the media display device.

Depending upon the qualities of the 3D image displayed on the screen 24 of a media device 20, the optics system 100 used to provide a user the 3D image can incorporate one or more optical components. In specific embodiments, the optics system 100, or portions thereof, can be arranged and maintained within the chamber 58 of a housing, such as the embodiments shown in FIGS. 1A-1D and 2A-2D.

In a particular embodiment, the optics system 100 utilized can be an accessory worn by the user. In a specific embodiment, for example, as shown in FIG. 4, the optics include dual close focus lenses 110 incorporated into typical eye glass frame as illustrated. In a specific embodiment, the dual close focus lenses 110 are used by themselves. In a further particular embodiment, for example, as shown in FIG. 4, the eye glass optics are employed with a housing frame 60 that includes a bottom panel 73 and an image separator panel 78. In a specific embodiment, the housing frame 60 holds the eye glass frame and lenses at the correct distance from the media device for a user to see a 3D image. With the embodiment shown in FIG. 4, the 3D image can be shown to a user through the close focus viewing lenses 110.

Other types of 2D images used to create a 3D image can include various misalignments, displacements, modifications to aspect ratios, anamorphic distortions, and other image altering distortions that can utilize one or more manipulations prior to presentation to a user to create the desired 3D image. To achieve these manipulations, an optics system 100 that can include any of a variety of optics can be utilized, including, but not limited to, lenses, prisms, mirrors, reflectors, filters, and/or other optical components. Advantageously, the optics system 100 of specific embodiments of the subject invention can utilize passive optic components. These optical components can be used to observe one or more 2D images from a media device 20 and, optionally, alter, normalize, or otherwise manipulate those images. In a specific embodiment, 2D images are generated with spatial offsets for the left and right eye, which when shown in the user's left and right eyes, respectively, are perceived by the user as a single 3D image. In a more specific embodiment, two multiple sequential 2D images (e.g., movie or film presentation) having spatial offsets for the left and right eyes are perceived by the user as a single, moving 3D image or video. A housing, as disclosed in reference to specific embodiments, can be beneficial in that it can allow optimal placement of optics, for example within the chamber 58, to ensure accurate manipulation of the 3D image presented to a user.

FIG. 3 shows an exploded view of one embodiment of an optical system that can be utilized incorporated within a housing 50, for providing a 3D image via a media player. In this embodiment, two 2D images, or image frames, are presented, or painted, vertically, that is, one above the other, on the screen 22 of a media player. A system of prisms and lenses can be used to separate and align the two images for the left and right eye of the user. The 2D images are generated with spatial offsets for the left and right eye to provide a 3D image from the dual 2D images. Referring to FIG. 3, prisms 120 receive the images from the media player such that the higher image for the left eye is brought down and the lower image for the right eye is raised, such that the two images are level with each. The close focus viewing lenses 110 then focus the images and horizontal displacement lenses 130 spread the left and right images apart so as to accommodate the width of the user's eyes. In the embodiment shown in FIG. 3, the first prism the image enters after passing through the close focus viewing lenses turns the images out away from the central axis, and the combination of the two lenses 130 provides anamorphic correction of the images in the horizontal direction. Although, the path of the images upon reaching the user are preferably parallel and parallel to the central longitudinal axis, the images can also be on the path continuing away from the central longitudinal axis, when the horizontal spacing of the images is in the range 60-65 mm, which corresponds well to the typically horizontal spacing of the user's eyes. The images then are presented to the user. The order of these components can be altered, additional components can be used, and/or different components can be substituted, depending on the circumstances.

It should be understood in this and the following examples that the media player can receive the right and left image in a non-normalized (landscape) perspective or a normalized (portrait) perspective on the media player, with the images stacked either vertically (one above the other) or juxtaposed (side by side). In a specific embodiment, one or more of the right and left images can include one or more anamorphic distortions, whereby the images can be squashed or sketched along one or both axes, to optimize the use of the pixels on the display. Such distortions can alter the aspect ratio, which can then be restored or normalized for the viewer by, for example, corrective optics.

In a specific embodiment, illustrated, for example, in FIG. 3, the media device can be observed in a vertical or portrait position. In this position, original dual 2D images 90 can each be presented in a normalized orientation and stacked one above the other. A set of alignment prisms 120 arranged in opposite directions can be used to re-align the 2D images in a juxtaposed position. Close focus viewing lenses 110 can further adjust the images, so the user can observe them at a proper distance. A system of horizontal displacement prisms 125 can further be employed to separate and align the images with the eyes of a user. As seen in FIG. 3, with this optical configuration, the original dual 2D images 90 can be manipulated, so that the final 2D images 95 are side by side and aligned for the user's eyes. The user can now accurately and comfortably observe the dual 2D images, which can be perceived as a single 3D image.

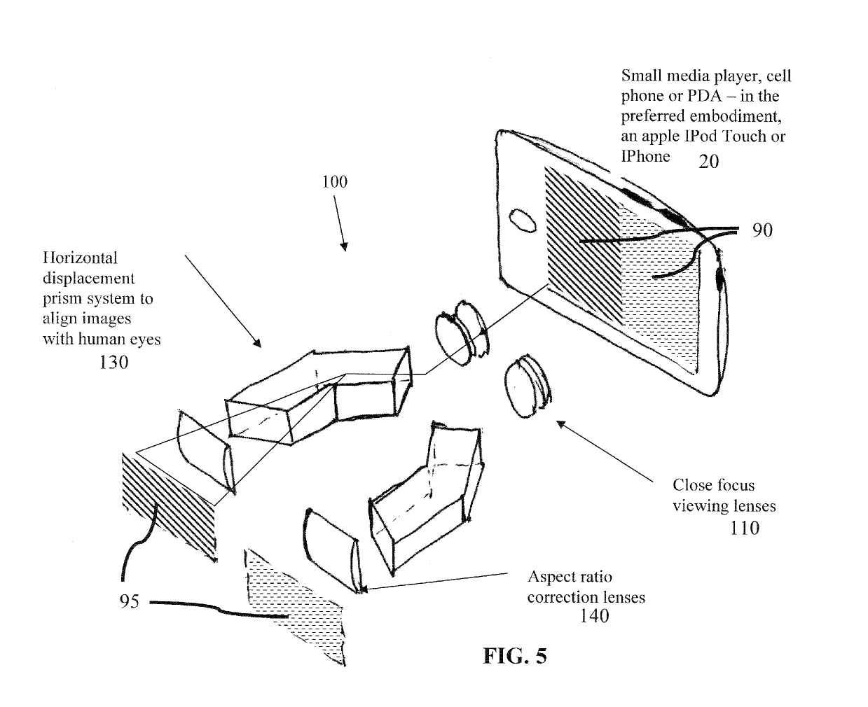

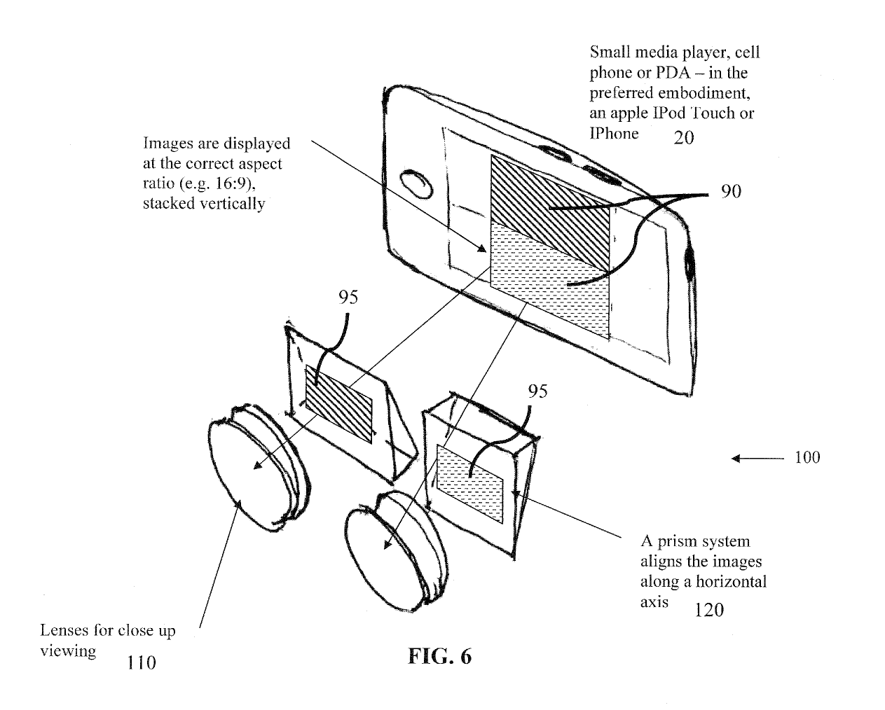

FIG. 5 shows another embodiment of an optical system that can be used to provide a 3D image to a user. In this embodiment, two original 2D images 90 are presented in a juxtaposed and normalized orientation, on the screen 22 of a mediaplayer. A system of prisms and lenses can be used to separate and align the two images with the eyes of the users for comfortable viewing. In a further embodiment, to make use of all the pixels in the display, the aspect ratio of the original 2D images can be compressed horizontally in the original media, then the altered aspect ratio can be corrected to a normal aspect ratio by the optic system. The original 2D images on the display can be generated with spatial offsets for the left and right eye to provide 3D viewing.

In a specific embodiment, illustrated, for example, in FIG. 5, the media device can be observed in a landscape position. In this position, the original dual 2D images 90 can be juxtaposed in a normalized orientation. Anamorphic distortion can further be incorporated that horizontally compresses the image, thus altering the aspect ratio. A set of close focus viewing lenses 110 can adjust the images, so the user can observe at a proper distance. A system of horizontal displacement prisms 130 can be utilized to align the images with the eyes of the user. To compensate for the altered aspect ratio, one or more aspect ratio lenses 130 can be used to correct the image. As seen in FIG. 5, with this optical configuration, the original 2D images 90 can be manipulated, so that the final 2D images 95 have the proper aspect ratio and are aligned for the user's eyes. The user can now observe the dual 2D images, which can be perceived as a single 3D image.

FIG. 6 shows still another embodiment of an optical system that can be used to provide a 3D image to a user from a “wide-screen” format (16:9 ratio) media. In this embodiment, the media device can be observed in a landscape position. In this position, the original dual 2D images can each be arranged in a stacked and normalized orientation on the media device screen 22 in a wide screen aspect ratio (16:9). In a further embodiment, the 2D images have a correct aspect ratio. The optics system can be used to adjust the apparent positions of the images for left and right viewing. More specifically, alignment prisms 120 can be used to juxtapose the 2D images for normal observation. Further, close focus viewing lenses 110 can be used to adjust the images, so the user can observe at a short distance. As seen in FIG. 6, with this optics system, the original 2D images 90 can be manipulated by the optics, so that the final 2D images 95 are juxtaposed and aligned for the user's eyes. The user can now observe the dual 2D images, which can be perceived as a single 3D image.

FIGS. 7A, 7B, and 7C show housing embodiments designed to hold a media device that is used to display an image for a viewer's, or user's, right eye and an image for a user's left eye to provide a 3D image. FIGS. 7B and 7C show an embodiment where the media device is aligned and maintained in a portrait or vertical position. FIG. 7A shows an embodiment where the media device is aligned and maintained in a landscape or horizontal position. In alternative designs, the housing can be designed to align and maintain the media device in either landscape or portrait orientation. The housing 50 can be enclosed to provide the benefit of eliminating distractions and providing better apparent brightness and clarity when observing the 3D images.

Still another embodiment, uses an optics system 100 using one or more mirrors to direct the right and left images displayed by a media device to the respective eyes of the user. In this embodiment, the media device can be in a landscape orientation. Two images can be presented juxtaposed on the screen of the media device. A system of mirrors and lenses can be used to move the two 2D images apart for comfortable viewing. In a further embodiment, to make use of all the pixels available in the display, the aspect ratio of the dual images can be altered by being compressed horizontally and/or vertically in the original media, then corrected to a normal aspect ratio by cylindrical lenses. The original 2D images can be generated with spatial offsets for the left and right eye to provide 3D viewing.

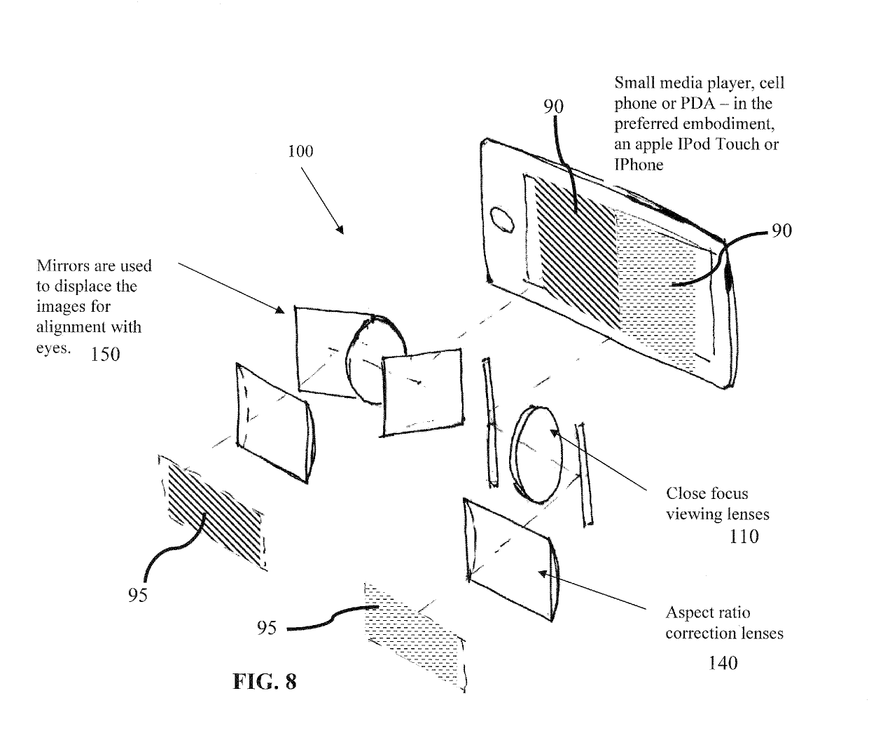

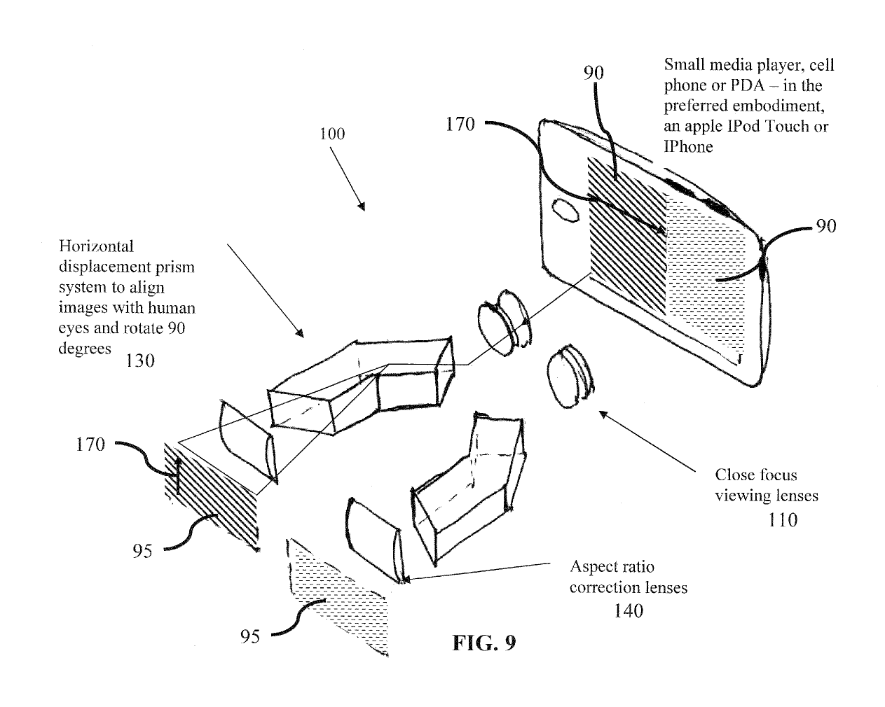

In a specific embodiment, an example of which is shown in FIG. 8, the media device can be observed in a landscape position. In this position, the original dual 2D images 90 can be juxtaposed in a portrait orientation. In a further specific embodiment, the aspect ratio of the image has been altered so that it has been horizontally compressed. In this embodiment, the mirror system 150 moves the images on the display a distance apart, so that they are more comfortably aligned with the user's eyes. Placing the close focus viewing lenses between the minors, or reflectors, allows the size of the mirrors, or reflectors, to remain smaller, allowing the size of the viewer to stay smaller. The mirror system can also direct the images through close focus viewing lenses 110, for observation at a short distance. To compensate for the horizontally altered aspect ratio, one or more aspect ratio 140 lenses can be used correct the image. As seen in FIG. 8, with this optical configuration, the original 2D images 90 can be manipulated by the optics, so that the final 2D images 95 are juxtaposed, have the proper aspect ratio, and are aligned for the user's eyes. The user can now observe the dual 2D images, which can be perceived as a single 3D image.

FIG. 9 shows yet another embodiment of an optical system, which is similar to the embodiment shown in FIG. 5, for displaying a 3D image to a user. The images can be presented on the media device in a juxtaposed non-normalized orientation. In this embodiment, a horizontal displacement prism system 160 aligns original 2D dual images with the viewer's eyes and further rotates the images to a normalized orientation.

In a specific embodiment, shown in FIG. 9, the two original 2D images 90 are presented juxtaposed, but in a non-normalized orientation. In a more specific embodiment, each image is non-normalied by rotating either −90° or +90° on the screen 22 of a media player 20. To demonstrate, FIG. 9 includes an orientation line 170 on the original 2D images 90 and the viewed images 95. In this embodiment, a system of prisms and lenses can be used to separate and align the two images with the eyes of the user for comfortable viewing. In a further embodiment, to make use of all the pixels in the display, the aspect ratio of the original 2D images can be also altered by horizontal compressed in the original media, then can be corrected to a normal aspect ratio by the optics. The original 2D images on the display can be generated with spatial offsets for the left and right eye to provide 3D viewing.

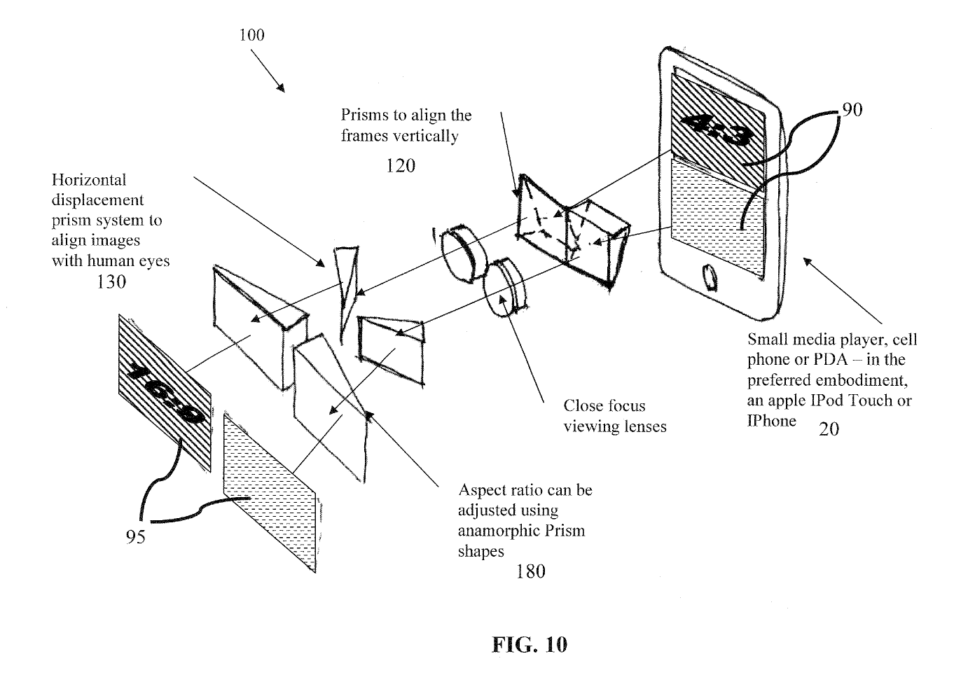

In a specific embodiment, illustrated, for example, in FIG. 9, the media device 20 can be observed in a landscape position. In this position, the original dual 2D images 90 can be juxtaposed, but non-normalized by rotating, for example, −90° (note the orientation line 170 on the original 2D images is horizontal). The aspect ratio of the images can also altered by horizontal compression to maximize pixel usage. Close focus viewing lenses 110 can adjust the images, so the user can observe them at a short distance. A system of horizontal displacement prisms 125 can be used to move the images apart so that they are aligned with the user's eyes. The horizontal displacement prisms 125 can further rotate the images, in this example +90°, to a normalized viewing aspect (note the orientation line 170 on the viewed image 95 is vertical). Other embodiments can rotate the images −90°, 180°, or any other angle that would provide desired viewing by the user. Although the embodiments shown in the Figures have the media display device positioned vertically or horizontally, the media display device can be positioned at any desired angle, the images can be displayed at any desired angle with respect to the display device, and the images can be rotated by the appropriate optical components to provide the user the images at the desired angle. One or more aspect ratio 130 lenses can be used to compensate for the horizontally altered aspect ratio. As seen in FIG. 9, with this optical configuration, the original non-normalized, compressed 2D images 90 can be manipulated by the optics, so that the final 2D images 95 are aligned to the users eyes and normalized with a proper aspect ratio so that the user perceives a single 3D image. FIG. 10 shows yet another alternative embodiment of an optical system, which is similar to the system of FIG. 3, which can also be used to provide a 3D image via a media player. In this embodiment, a media player can receive the right and left image in landscape or portrait orientations on the media player, with the images stacked or juxtaposed. The 2D images can be generated with spatial offsets for the left and right eye to provide a 3D image from the dual 2D images. One or more of the right and left images can have an altered aspect ratio by compression along one or both axes to optimize the use of the pixels on the display. The aspect ratio can then be restored for the viewer by, for example, corrective optics, in a specific embodiment, including an anamorphic prism system.

In a specific embodiment, illustrated, for example, in FIG. 10, the media device can be observed in a portrait position. In this position, original dual 2D images 90 can each be arranged in a normalized orientation and stacked. The aspect ratio of the images can further be compressed. In a specific embodiment, the aspect ratio of the images can be compressed to a 4:3 ratio. A set of alignment prisms 120 arranged in opposing directions can be used to juxtapose the 2D images. Close focus viewing lenses 110 can further adjust the images, so the user can observe at a short distance. A system of horizontal displacement prisms 130 can used to move the images apart, so that they are aligned with the eyes of the user. In a further specific embodiment, one or more anamorphic prisms 180 are used to correct the compressed image to the correct aspect ratio. In the specific embodiment used above, a 4:3 aspect ratio can be corrected by the anamorphic prisms 180 to a more normalized 16:9 aspect ratio. As seen in FIG. 10, with this optical configuration, the original 2D images 90 can be manipulated with the optic sysem 100, so that the final 2D images 95 are juxtaposed with a normal aspect ratio and aligned for the user's eyes. The user can now observe the dual 2D images, which can be perceived as a single 3D image.

The embodiments shown in FIGS. 1-10 can be used in conjunction with a system for delivering 3D images, such as, for example, 3D videos, to a viewer via a media player. The delivery system can utilize the internet or other communication system to deliver the 3D image or 3D video data to the media player. The delivery system can incorporate security features, such as, for example, non-normalized orientation and altered aspect ratios, to restrict the handheld media player to only play media files having the proper security information. In a specific embodiment, distortions such as anamorphic distortions can be introduced in the media files that are difficult to eliminate without use of the appropriate viewing system. In a further specific embodiment, the distortion can maximize the number of pixels available for each frame.

As described herein, the optic system of a viewer can, in general, include one or more lenses, prisms, mirrors, and/or other optical components arranged in various configurations, to achieve the effect of a 3D image, as well as, in some embodiments, protect the image from unauthorized users. In certain embodiments disclosed herein, the use of passive optical components provides the viewer with the advantages of portability, accessibility, ease of use and diverse compatibility. Without the necessity of integrated software, the viewer 10 can be easily made compatible or adaptable for use with any of a variety of handheld media.

Embodiments of the invention relate to a method and system for providing 3D images, such as music videos, and movies to users over the internet or other communication channels, such as cell phone communication channels. In a specific embodiment, a symbol, code, or other physical or symbol representation can be made available to the user such that the user can then use the same to request the 3D image, videos, etc. As an example, a 2D bar code, or other representation, can be positioned on the embodiment shown in FIGS. 2A-2D, which can be sold or otherwise distributed to users. The user can then take a picture of the 2D bar code with a media display device, or other device, and send it to a website, email address, or other portal for requesting the 3D images, videos, etc., or enter the other representations such as a password to an appropriate portal, such as text message, email, or other form of communication. Such communication can then trigger the 3D images, videos, etc. to be transmitted to the 3D media display device for viewing by the user in accordance with one or more of the embodiments for viewing the 3D images disclosed herein or other type of 3D image.

As discussed, various embodiments of the invention can involve positioning the right and left images on the screen of the media display device in various positions, orientations, aspect ratios, and relative positions. Such compression and/or stretching of the images, in one and/or two dimensions, can be used to make the 3D images difficult to view property without a viewer designed to modify the image in the appropriate manner to show the user.

Although embodiments show circular and rectangular close focus viewing lenses, where the cross-sectional shapes are taken along the optical axis other shapes can also be utilized, including, but not limited to, hexagonal, polygonal, oval, elliptical, and square. Lenses with various focal lengths can also be used. In specific embodiments, consistent with the embodiments taught in the specification, close focus viewing lenses can be used having focal lengths in the range 60-120 mm, in the range of 80-105 mm, and/or in the range 90-110 mm, which allow a small enough device and 3D images of a size enjoyable to view for may users.

The viewers, methods, and other systems in accordance with embodiments of the invention can use right and left images taken with stereoscopic instruments, created from existing 2D images, or other created so that when the right image is presented to the user's right eye and the left image is presented to the user's left eye, the user perceives a 3D image.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. An apparatus for presenting images to a user such that the user perceives a 3D image, comprising:
a frame, wherein the frame is capable of holding a handheld media display device displaying a right input image and a left input image,
a right close focus viewing lens, wherein the right close focus viewing lens is attached to the frame, wherein the right input image is positioned such that a right optical path length from the displayed right input image to the right close focus viewing lens is approximately a right focal length of the right close focus viewing lens such that the right input image enters the right close focus viewing lens and exits the right close focus viewing lens for viewing by a user's right eye; and
a left close focus viewing lens, wherein the left close focus viewing lens is attached to the frame, wherein the left input image is positioned such that a left optical path length for the left input image to the left close focus viewing lens is approximately a left focal length from the displayed left close focus viewing lens such that the left input image enters the left close focus viewing lens and exits the left close focus viewing lens for viewing by a user's left eye;
wherein when the user positions the user's right eye to receive the right output image with the user's right eye and positions the user's left eye to receive the left output image with the user's left eye, the user perceives a 3D image.

2. The apparatus according to claim 1, wherein the right input image displayed on the handheld media display device and the left input image displayed on the handheld media display device are a stereoscopic pair of images.

3. The apparatus according to claim 1, further comprising:
a second frame, wherein the second frame is attached to the first frame, wherein the second frame is capable of being worn on the user to hold the right close focus lens in position with respect to the user's right eye and hold the left close focus lens in position with respect to the user's left eye.

4. The apparatus according to claim 1, further comprising a barrier, wherein the barrier is attached to the frame so as to allow the user's right eye to see the right output image, allow the left eye to see the left output image, prevent the user's right eye from seeing the left output image, and prevent the user's left eye from seeing the right output image.

5. The apparatus according to claim 1, further comprising:
a right aligning system, wherein the right aligning system is positioned such that the right input image passes through the right aligning system, wherein the right input image is displayed on the handheld media display device at a first right vertical position with respect to the user's right eye, wherein the right input image exits the right aligning system at a second right vertical position with respect to the user's right eye.

6. The apparatus according to claim 5, wherein the right input image displayed on the handheld media display device passes through the right aligning system and enters the right close focus viewing lens.

7. The apparatus according to claim 5, wherein the right aligning system comprises a right aligning prism.

8. The apparatus according to claim 1, further comprising:
a left aligning system, wherein the left aligning system is positioned such that the left input image passes through the left aligning system, wherein the left input image is displayed on the handheld media display device at a first left vertical position with respect to the user's left eye, wherein the left input image exits the left aligning system at a second left vertical position with respect to the user's left eye.

9. The apparatus according to claim 8, wherein the left aligning system comprises a left aligning prism.

10. The apparatus according to claim 5, further comprising:
a left aligning system, wherein the left aligning system is positioned such that the left input image passes through the left aligning system, wherein the left input image is displayed on the handheld media display device at a first left vertical position with respect to the user's left eye, wherein the left input image exits the left aligning system at a second left vertical position with respect to the user's left eye.

11. The apparatus according to claim 10, wherein the left aligning system comprises a left aligning prism.

12. The apparatus according to claim 1, further comprising:
a right displacement system, wherein the right displacement system is positioned such that the right input image passes through the right displacement system, wherein the right input image is displayed on the handheld media display device at a first right horizontal position with respect to the user's right eye, wherein the right input image exits the right horizontal displacement system at a second right horizontal position with respect to the user's right eye.

13. The apparatus according to claim 12, wherein the right displacement system comprises a right displacement prism.

14. The apparatus according to claim 12, wherein the right horizontal displacement comprises at least two mirrors.

15. The apparatus according to claim 1, further comprising:
a left displacement system, wherein the left displacement system is positioned such that the left input image passes through the left displacement system, wherein the left input image is displayed on the handheld media display device at a first left horizontal position with respect to the user's left eye, wherein the left input image exits the left horizontal displacement system at a second left horizontal position with respect to the user's left eye.

16. The apparatus according to claim 15, wherein the left displacement system comprises a left displacement prism.

17. The apparatus according to claim 15, wherein the left horizontal displacement comprises at least two mirrors.

18. The apparatus according to claim 12, further comprising:
a left displacement system, wherein the left displacement system is positioned such that the left input image passes through the left displacement system, wherein the left input image is displayed at a first left horizontal position with respect to the user's left eye, wherein the left input image exits the left horizontal displacement prim system at a second left horizontal position with respect to the user's left eye.

19. The apparatus according to claim 18, wherein the left displacement system comprises a left displacement prism.

20. The apparatus according to claim 18, wherein the left horizontal displacement system comprises at least two mirrors.

21. The apparatus according to claim 1, further comprising:
a right aspect ratio correction lens, wherein the right aspect ratio correction lens is positioned such that the right input image passes through the right aspect ratio correction lens, wherein the right input image is displayed on the handheld media display device having a first right aspect ratio, wherein the right input image exits the right aspect ratio correction lens having a second right aspect ratio.

22. The apparatus according to claim 1, further comprising:
a left aspect ratio correction lens, wherein the left aspect ratio correction lens is positioned such that the left input image passes through the left aspect ratio correction lens, wherein the left input image is displayed on the handheld media display device having a first left aspect ratio, wherein the left input image exits the left aspect ratio correction lens having a second left aspect ratio.

23. The apparatus according to claim 21, further comprising:
a left aspect ratio correction lens, wherein the left aspect ratio correction lens is positioned such that the left input image passes through the left aspect ratio correction lens, wherein the left input image is displayed on the handheld media display device having a first left aspect ratio, wherein the left input image exits the left aspect ratio correction lens having a second left aspect ratio.

24. The apparatus according to claim 1, further comprising:
a right rotation system, wherein the right rotation system is positioned such that the right input image passes through the right rotation system, wherein the right input image is displayed on the handheld media display device with a first angular orientation with respect to the user's right eye, wherein the right input image exits the right orientation system at a second angular orientation with respect to the user's right eye.

25. The apparatus according to claim 24, wherein the second angular orientation is rotated plus or minus 90 degrees with respect to the first angular orientation.

26. The apparatus according to claim 1, further comprising:
a left rotation system, wherein the left rotation system is positioned such that the left input image passes through the left rotation system, wherein the left input image is displayed on the handheld media display device with a first angular orientation with respect to the user's left eye, wherein the left input image exits the left orientation system at a second angular orientation with respect to the user's left eye.

27. The apparatus according to claim 26, wherein the second angular orientation is rotated plus or minus 90 degrees with respect to the first angular orientation.

28. The apparatus according to claim 26, wherein the left rotation system is positioned such that the left input image passes through the left rotation system, wherein the left input image is displayed on the handheld media display device with a first angular orientation with respect to the user's left eye, wherein the left input image exits the left orientation system at a second angular orientation with respect to the user's left eye.

29. The apparatus according to claim 28, wherein the second angular orientation is rotated plus or minus 90 degrees with respect to the first angular orientation.

30. The apparatus according to claim 1, wherein the right focal length of the right close focus viewing lens and the left focal length of the left close viewing lens are in the range 60 mm to 120 mm.

31. The apparatus according to claim 1, wherein the right focal length of the right close focus viewing lens and the left focal length of the left close viewing lens are in the range 80 mm to 105 mm.

32. The apparatus according to claim 1, wherein the right focal length of the right close focus viewing lens and the left focal length of the left close viewing lens are in the range 90 mm to 110 mm.

33. The apparatus according to claim 1, wherein the frame is capable of holding the handheld media display device in a position such that the right optical path length and the left optical path length are in the range 60 mm to 120 mm.

34. The apparatus according to claim 1, wherein the frame is capable of holding the handheld media display device in a position such that the right optical path length and the left optical path length are in the range 80 mm to 105 mm.

35. The apparatus according to claim 30, wherein the frame is capable of holding the handheld media display device in a position such that the right optical path length and the left optical path length are in the range 90 mm to 110 mm.

36. The apparatus according to claim 1, wherein the right close focus viewing and the left close focus viewing lens are removably attached to the frame.

37. The apparatus according to claim 1, wherein the right close focus viewing and the left close focus viewing lens are fixedly attached to the frame.

38. The apparatus according to claim 1, further comprising an adjustor, wherein the adjustor can adjust the right optical path length from the displayed right input image to the right close focus viewing lens by adjusting the position of the handheld media display device and/or the position of the right close focus viewing lens.

39. The apparatus according to claim 1, wherein the handheld media display device is selected from the group consisting of: IPhone, IPod Touch, a personal digital assistant (PDA), Blackberry®, cellular phone, and IPad.

40. A method for presenting images to a user such that the user perceives a 3D image, comprising:
providing a frame capable of holding a handheld media display device;
positioning the handheld media display device so that the frame is holding the handheld media device;
displaying a right input image and a left input image on the handheld media display device;
providing a right close focus viewing lens, attached to the frame, wherein the right close focus viewing lens is positioned such that a right optical path length from the displayed right input image to the right close focus viewing lens is approximately a right focal length of the right close focus viewing lens such that the right input image enters the right close focus viewing lens and exits the right close focus viewing lens for viewing by a user's right eye;
providing a left close focus viewing lens, attached to the frame, wherein the left close focus viewing lens is positioned such that a left optical path length for the left input image to the left close focus viewing lens is approximately a left focal length from the displayed left close focus viewing lens such that the left input image enters the left close focus viewing lens and exits the left close focus viewing lens for viewing by a user's left eye;
positioning the user's right eye to receive the right output image with the user's right eye and
positioning the user's left eye to receive the left output image with the user's left eye, wherein the user perceives a 3D image upon receiving the right output image with the user's right eye and the left output image with the user's left eye.
